(19) United States
(12) Patent Application Publication
(10) Pub. No.: US 2005/0126077 A1
(43) Pub. Date: Jun. 16, 2005

(54) Glass-scraper seal for windows which can be opened and are fitted with sliding glass, in particular for motor vehicles

(76) Inventors: Paolo Cittadini, Luvinate (IT); Marco De Giorgi, Varese (IT)

Correspondence Address: Abelman Frayne & Schwab, 150 East 42nd Street, New York, NY, 10017-5612, US

(21) Appl. No.: 10/503,157

(22) PCT Filed: Jan. 13, 2003
(86) PCT No.: PCT/EP03/00282

(30) Foreign Application Priority Data
Jan. 28, 2002 (IT) MI2002A000141

(51) Int. Cl. B60J 1/16

(52) U.S. Cl. 49/377

(57) ABSTRACT

A glass-scraper seal used in windows which may be opened and are fitted with sliding glass, in particular for motor vehicles, with the glass-scraper seal having a portion capable of flexing elastically under the action of the glass so as to form a seal against a portion arranged opposite it, in each of the two opposite portions of the seal there being arranged at least one magnetic element, respectively, the surface of which facing that of the magnetic element of the opposite portion having an identical polarity such as to produce between them a repulsive magnetic force.

### CROSS-REFERENCE TO RELATED APPLICATIONS

This application is a 371 of PCT/EP03/00282, filed on Jan. 13, 2003.

### BACKGROUND OF THE INVENTION

1. Field of the Invention

The present invention relates to a glass-scraper seal suitable in particular for forming a seal on windows which can be opened and are fitted with sliding glass, in particular for motor vehicles.

2. Description of the Related Art

As is known, the side windows of motor vehicles are commonly able to be opened by means of sliding glass provided with sealing and insulating systems along their perimeter (for example U.S. Pat. No. 6,082,048).

In particular, the seal along the horizontal edge of the panel of the door along which the glass of a side window slides is formed by means of seals which are called “glass-scraper” (or also “glass-hugging”) seals. The main function of these sealing systems is that of preventing water and dirt from being able to penetrate inside the structure of the door, damaging the internal parts thereof. They must also help keep the glass in position, limiting to a minimum the vibrations thereof, and reduce the noisiness during travel. Together with the requirement of providing a constant seal, a glass-scraper seal must at the same time allow the opening and closing (to-and-fro) movement of the glass inside the panel of the door to be always smooth, without the risk of jamming or seizing.

In general a glass-scraper seal comprises an element for fixing to the door panel and a flexible sealing element in the form of a lip (for example U.S. 6,082,048) or a seal with a closed cross-section (for example GB 2110281). In any case the surface intended to come into contact with the glass is flocked or in any case covered with a film of other suitable material having a low coefficient of friction, so as to facilitate the upward and downward movement of the glass.

The growing requirements for an aerodynamic and low-noise performance during travel have recently resulted in the increasingly common usage of doors with windows which are flush with the bodywork (“flush systems”). To ensure an adequate seal, this solution requires the use of glass-scraper seals which exert a high compressive force on the glass, which for this reason, makes its movement more difficult.

Moreover, flexible sealing elements operating under compression with high loads are subject to a premature loss of operating efficiency owing to the reduction in the elastic response of the rubber element on the glass itself and become elements which are extremely rigid at low temperatures.

This elastic response or thrust varies owing to the effect that the variations in temperature produce on the elastic properties of the polymer material from which the seal is made and also deteriorates over time owing to the permanent deformations which arise with aging of the seal during use. This phenomenon is represented by the compression set value of the material.

This problem is accentuated in the case where, instead of cross-linked rubbers, thermoplastic elastomers are used, the latter being preferred because of their recyclability.

As a possible solution to the limitations of the seals discussed above, some patents have proposed seals having a generally complex shape and comprising magnetic inserts. In general, in order to be able to perform their function, these seals must come into contact with a wall of ferromagnetic material: in the case of a glass window, it is necessary to envisage the application of ferromagnetic metal inserts or magnets onto the glass itself or laterally with respect thereto. Obviously, in order to produce a force of attraction between the magnets, the polarization of the magnets must be such that facing surfaces with opposite poles (N/S or S/N) are arranged opposite each other and, if the glass has a thickness greater than 2 mm, the force of attraction between two opposite magnets drops considerably, being of limited effectiveness.

The patents U.S. 4,535,563 and EP 0369799 describe seals which are of this type, but which are applied only to the upper lateral guiding profiles of the window and not to the horizontal bottom glass-scraper profile.

A similar magnetic sealing system for the bottom side of the window is described by the patent FR 2555650. In this latter case, the magnets start to function only when the glass is located in the closed position since the counter-pole is fixed in the bottom portion thereof, whereas when the window is open the seal is ensured by an elastic element acting with compression against the window and therefore having those limitations described above.

### BRIEF SUMMARY OF THE INVENTION

The object of the present invention is to find an effective solution to the set of technical problems described above.

In order to achieve this object, the present invention proposes a glass-scraper seal for windows which can be opened and are fitted with sliding glass, in particular for motor vehicles, characterized in that it comprises a portion capable of flexing elastically under the action of the glass so as to form a seal against a portion arranged opposite it, in each of the two opposite portions of the seal there being arranged at least one magnetic element, the surface of which facing that of the magnetic element of the opposite portion having an identical polarity such as to produce between them a repulsive magnetic force which ensures a constant seal on the glass.

### BRIEF DESCRIPTION OF THE SEVERAL VIEWS OF THE DRAWINGS

In order to understand better characteristic features and advantages of the invention, a practical non-limiting example of embodiment of the invention is described below, with reference to the figures of the accompanying drawings.

FIG. 1 shows a cross-sectional view of a seal according to the invention.

FIG. 2 shows a similar cross-sectional view of the seal according to FIG. 1 operational mounted on a motor vehicle, in the sealing position between glass and door.

FIG. 3 shows a cross-sectional view of a variant of a seal according to the invention.

### DETAILED DESCRIPTION OF THE INVENTION

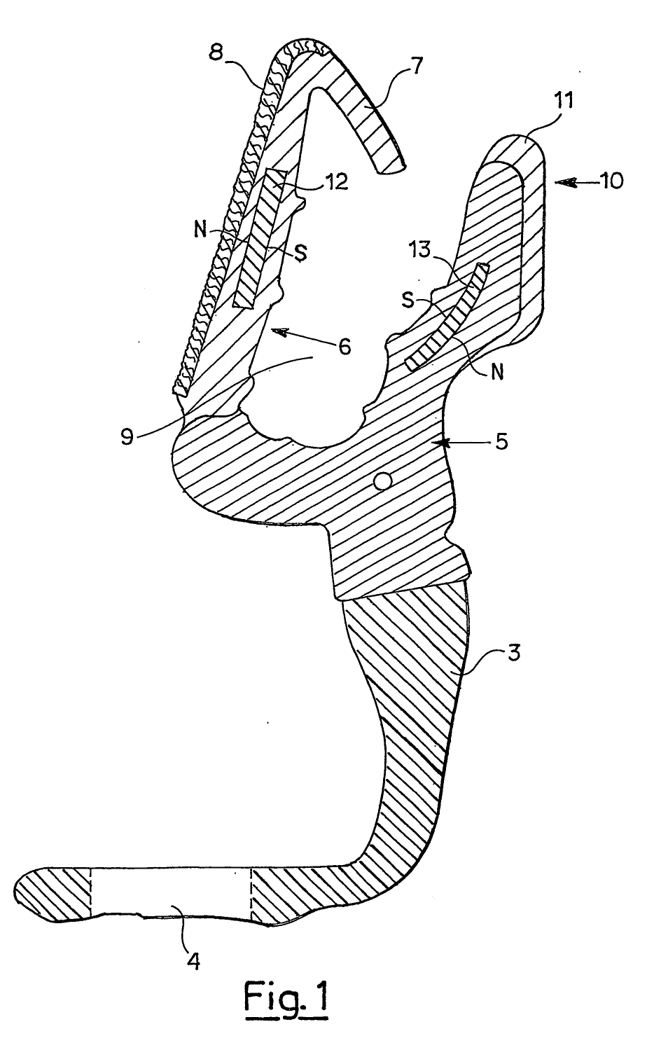

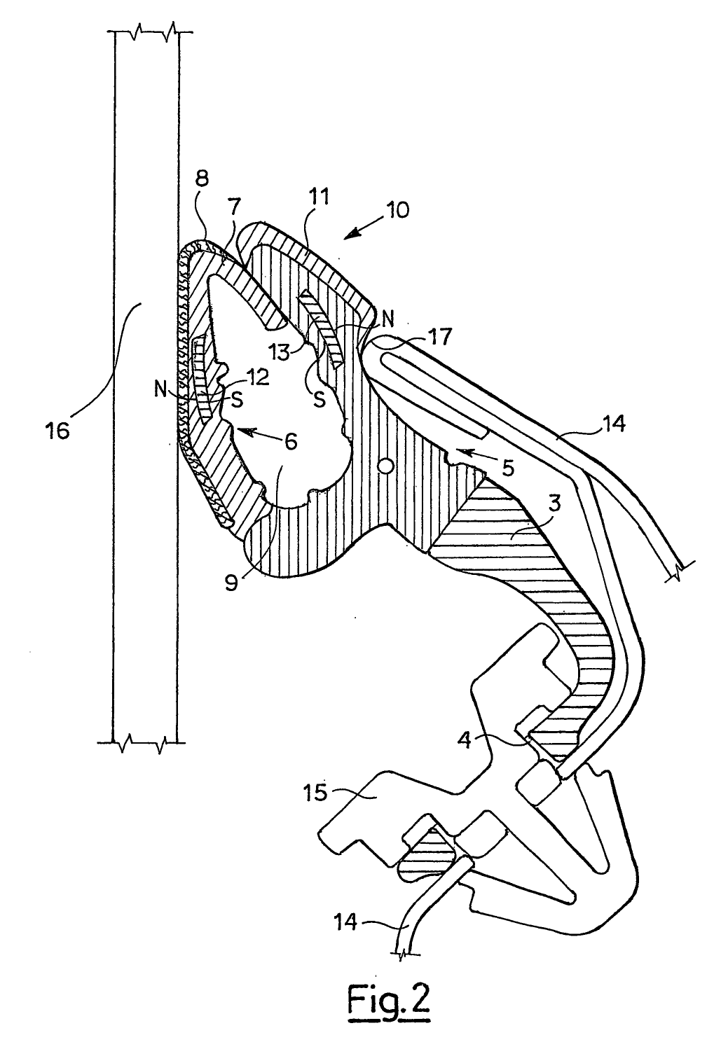

With reference to FIGS. 1 and 2, a glass-scraper seal 10 for windows which can be opened and are fitted with sliding glass has an approximately Y-shaped cross-section comprising a base portion 3 made of rigid material with a through-hole 4 for fixing to a vehicle, in particular to the sheet metal of a door. From the base portion there extends at the top, for example coextruded, a portion 5 which is made of elastomer material which is semi-rigid (for example ShA 85) and which is arranged opposite a portion 6 made of elastomer material with a lower hardness value (for example ShA 55) and therefore able to flex elastically under stress towards an interspace 9 which is defined between the two portions which are coextruded with each other. The portion 6 terminates at the top in a lip 7 which extends in the direction of the opposite portion 5, thus assuming an approximately C-shaped cross-section. Externally with respect thereto, on the surface which is operationally intended to make contact with the glass of the window, a strip 8 of polyester flock is combined so as to facilitate the sliding movement of the glass for opening and closing the window.

Externally with respect to the interspace 9, the portion 5 has in turn a coextruded layer 11 of plastic material with a lower hardness value, for example the same as that which forms the portion 6 of the seal.

Each of the two opposite portions 5 and 6 of the seal has, arranged inside it, respectively, a magnetic element 13 (in the portion 5) and 12 (in the portion 6), for example in the form of a strip of plastic ferrite coextruded with the material of the seal. In each strip 13 and 12 the surface facing that of the magnetic element of the opposite portion has a polarity which is identical to that of the latter.

In FIG. 1 this is represented schematically by the symbols S/S on the surfaces of the strips facing the interspace 9 and by the symbols N/N on the opposite surfaces, with reference to the polarities involved.

FIG. 2 shows the seal according to FIG. 1 operational mounted on the metal sheet of a door 14 of a motor vehicle along the frame of a side window which can be opened, more specifically its horizontal bottom edge, by means of a fixing element, for example a clip 15 which engages with the hole 4 provided in the base portion 3. The operative position shown is that where a sliding glass 16 of the window of the car on which the glass-scraper seal 10 is mounted is in the raised position, so that it interferes with the portion 6, causing elastic flexing of the portion 5. The latter, since it is made of material which is more rigid than the flexible opposite portion, stably bears against the top 17 of the metal sheet 14 and is not subject to any significant displacement as a result of the sliding action of the glass 16. The latter therefore causes only flexing of the portion 6 until the flexible lip 7 encounters the rigid portion 5, is deformed against it in the end-of-travel position shown in FIG. 2 and in this way produces the desired seal between glass and door. In this position the lip 7 produces an elastic thrusting action of the portion 6 of the seal, and therefore the flocked strip 8, against the glass 16, ensuring the seal.

Therefore, a repulsive force, which opposes the deformation exerted by the glass 16 on the portion 6 in the closed position of the window, is generated between the two magnetic elements 12 and 13 kept facing each other with the same opposing poles (S/S).

This force is used according to the invention to oppose the variation, in particular the deterioration, of the elastic properties of the material forming the seal both owing to the variations in temperature and owing to the permanent deformations which arise under compression over time owing to aging in the case of cross-linked rubbers, or in order compensate for the elastic return and compression set values in the case of thermoplastic materials or materials of limited thickness. The repulsive force generated in this way acts at all times, both in the operative closed position and in the rest condition, favoring restoration of the original shape of the glass-scraper seal 10, thereby achieving the object of the invention.

For the portions 5 and 6 of the seal according to the invention, it is possible to use materials preferably chosen from among EPDM rubber, thermoplastic rubbery materials based on terpolymers (SEBS, SEPS, SBS, SIS) and those belonging to the class of dynamically vulcanized thermoplastic elastomers such as Santoprene (PP/EPDM), which are preferred because of their recyclable nature.

The base 3, for example, may consist of polypropylene reinforced, for example with talc or glass fiber.

The elements consisting of magnetic material are preferably, but not exclusively, strips of plastic magnetic material, such as plastic ferrite, which are coextruded with the material which forms the seal.

Numerous variants of the invention may be realized with respect to that illustrated by way of example above, in particular as regards the geometry of the seal and the arrangement of the elements or the strips with magnetic properties necessary for producing the repulsive force indispensable for the objects of the invention.

The magnetic elements are preferably coextruded strips of plastic ferrite which are inserted inside the two portions of the seal, embedded therein, as shown in the abovementioned examples. However, according to the present invention, they be arranged in an equivalent manner in accordance with different embodiments, both as regards their position in the deformable and undeformable portion of the seal, and as regards their shape, dimensions and location. For example, they may have a form other than that of a strip, may be inserts which are not coextruded, but inserted in special seats in the seal, or may not be embedded in the seal, but be situated on the internal surface thereof facing the interspace defined between the two opposite portions so as to increase the mutual magnetic repulsive effect.

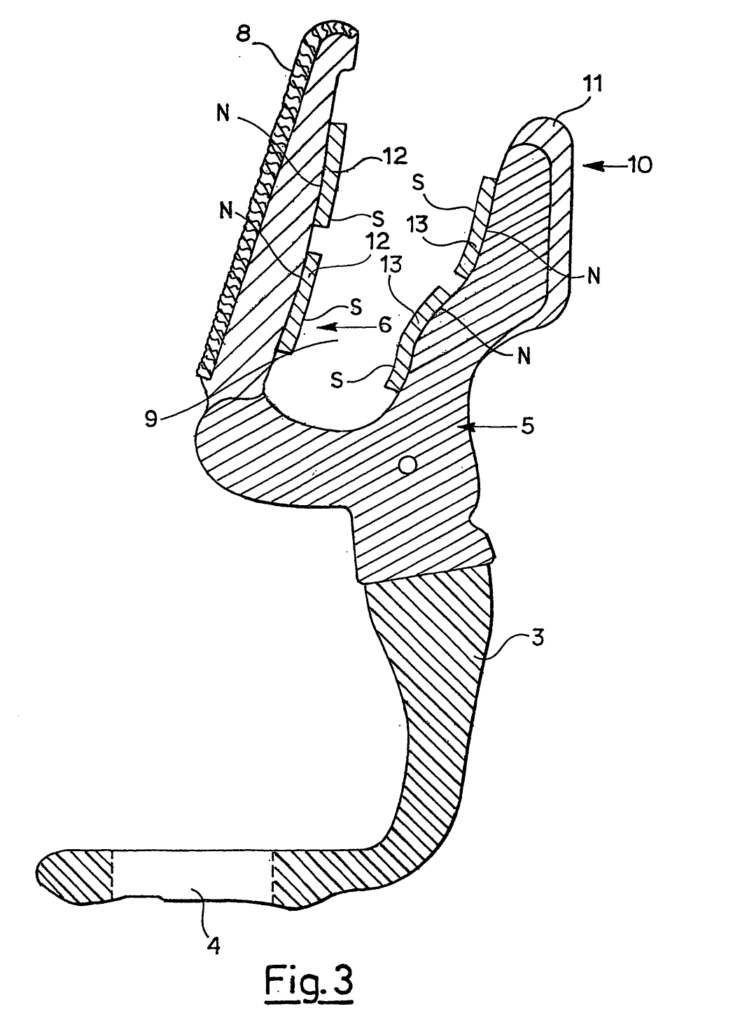

For example, in the variant shown in FIG. 3, the elements (12, 13) of magnetic material are arranged in a mutually facing position in the portions (6, 5) of the seal along their mutually facing surface and coextruded with these portions. As can be seen, in particular both the elements 12 coextruded on the internal surface of the portion 6 and the elements 13 coextruded on the internal surface of the portion 5 form a pair 12, 12 and 13, 13 respectively, still in keeping with the principle that the surface facing that of the magnetic element of the opposite portion has the same polarity so as to produce between them a repulsive magnetic force. In this case, since there is no material located between the pairs of magnetic elements which are directly coextruded onto the surface of the portions 5 and 6, and not embedded therein, the repulsive force which is exerted between them has a strength which is even greater or better distributed, such that the lip 7 present in the variant according to FIG. 1 may be dispensed with, this lip in the deformed position also performing the function, as described above, of elastically thrusting the flocked portion against the glass. In the embodiment according to FIG. 3, this thrust is adequately provided solely by the greater force of repulsion between the pairs 12, 13 of magnetic elements facing each directly without the presence of material.

As seen above in the variant shown in FIG. 3, according to the invention the magnetic elements may be a plurality of elements arranged as required in every zone where there is a greater risk of permanent deformations, provided this is in keeping with the fundamental teaching of the invention whereby they are able to produce in these zones of greater deformability a repulsive magnetic field such as to ensure a sealing action in the case where materials with poor mechanical properties are used or so as to oppose the effects of deformation caused by aging of the seal and a deterioration in its sealing properties in the case where thermosetting rubbers are used.

The desired magnetic characteristics are preferably obtained by means of magnetization in accordance with the techniques commonly used at an industrial level, for example by means of the magnetization with electromagnets or rare-earth magnets.

Moreover the choice of the most appropriate type of magnetic powder for example hard ferrites and rare earths, as well as its quantity, results in a wider range of magnetic properties for the elements or strips of magnetic material according to the invention, allowing the magnetic repulsive force to be suitably adjusted in each case depending on the form or design of the seal and the properties of the materials used.

The percentage by weight of magnetic powder contained in the powder plus polymer binder mixture, which generally usefully consists of low-hardness thermoplastic elastomers, may vary preferably between 40% and 95%.

The glass-scraper seal according to the invention may be likewise suitable for applications in fields other than the motor vehicle sector.

1. Glass-scraper seal for windows which can be opened and are fitted with sliding glass, in particular for motor vehicles, the glass-scraper seal comprising:
portions (5, 6), with the portion (6) capable of flexing elastically under the action of the glass so as to form a seal against the portion (5) arranged opposite the portion (6), in each of said two opposite portions (5, 6) of the seal there being arranged at least one magnetic element (12, 13), respectively, the surface of which facing that of the magnetic element (13, 12) of the opposite portion having an identical polarity such as to produce between them a repulsive magnetic force.

2. Seal according to claim 1, wherein the elements (12, 13) of magnetic material are coextruded with said portions (6, 5) of the seal.

3. Seal according to claim 2, wherein the elements (12, 13) of magnetic material are in the form of coextruded strips or laminae.

4. Seal according to claim 1, wherein the elements (12, 13) of magnetic material are arranged as inserts in seats formed in a mutually facing position in said portions (6, 5).

5. Seal according to claim 1, wherein the elements (12, 13) of magnetic material are arranged embedded in said portions (6, 5) of the seal in the vicinity of their mutually facing surface.

6. Seal according to claim 1, wherein the elements (12, 13) of magnetic material are arranged in a mutually facing position along their mutually facing surfaces.

7. Seal according to claim 1, wherein the portion (6) capable of flexing elastically under the action of the glass includes at least one sealing lip (7) which is operational deformed, bearing against the surface of said portion (5).

8. Seal according to claim 1, wherein a strip (8) of material with a low coefficient of friction, including a flocked strip, is applied onto said portion (6) in the direction of said sliding glass.

9. Seal according to claim 1, wherein the portion (5) has a coextruded layer (11) of plastic material having a lesser rigidity.

10. (canceled)
